(19) United States
(12) Patent Application Publication
(10) Pub. No.: US 2025/0205012 A1
(43) Pub. Date: Jun. 26, 2025

(54) MEDICAL OR DENTAL DEVICE FOR DISPENSING A PASTY OR LIQUID COMPONENT

(71) Applicant: PRODUITS DENTAIRES S.A., Vevey (CH)

(72) Inventors: Nicolas GEHRIG, Vevey (CH); David BRENDLEN, Vevey (CH); Shanon PATEL, Vevey (CH)

(21) Appl. No.: 18/842,694

(22) PCT Filed: Mar. 6, 2023
(86) PCT No.: PCT/IB2023/052077

§ 371 Date: Aug. 29, 2024

(30) Foreign Application Priority Data
Mar. 7, 2022 (WO) PCT/IB2022/051980

(51) Int. Cl. A61C 5/50

(52) U.S. Cl. CPC A61C 5/50

(57) ABSTRACT

The present invention relates to a device (1) for dispensing a pasty or liquid composition intended for a medical or dental use, and in particular for endodontic use. The device comprises a handle (1), a reservoir (2) for the pasty or liquid composition, at least one plunger (4) arranged to slide in the reservoir (2), at least one lever (3) arranged to be removably mounted on a mounting portion of the handle (10) and arranged to cooperate with the plunger (4) to cause said plunger (4) to slide in the reservoir (2) for the dispensing of the pasty or liquid composition contained therein when the reservoir (2) and the lever (3) are mounted on the handle (10). The lever (3) is arranged to be connected to the plunger (4) such that when the user presses on the lever (3) in the direction of the handle (10), the plunger (4) slides in the reservoir (2) along the longitudinal axis thereof and pushes the pasty or liquid composition out of said reservoir (2).

The present invention relates to a medical or dental device for dispensing a pasty or liquid composition. The present invention relates in particular to an endodontic device allowing the dispensing of a cement or pasty or liquid filling material intended to fill a section of a root canal or pulp chamber or coronal part of a tooth.

During endodontic treatment, the user removes infected tissue by shaping, cleaning, and disinfecting the treated root canal using a series of appropriate instruments. The canal is then dried using points (e.g. paper points) before being filled using cones (e.g. gutta-percha cones) and/or cements or other suitable filling pastes. To place these pasty or liquid filling materials (cement or pastes) in the shaped root canal, the user uses dedicated tools such as a spatula or a device similar to a syringe. However, the spatula does not allow precise dispensing of the filling material disposed in the canal to be achieved. Moreover, depending upon the position of the tooth and the area to be treated, it might prove difficult for a spatula to access the root canal. This is also true when managing events of the iatrogenic perforation type which occurs during endodontic instrumentation.

For greater precision, the user can use devices similar to syringes. Generally, these devices have a bend allowing the interior of the root canal being filled to be reached more easily. As is the case with a conventional syringe, with these devices the user actuates a plunger which pushes the filling material out of a tube.

For example, document EP 0 237 182 describes a device for dispensing a filling fluid comprising a handle, a cannula containing the filling fluid and a plunger system. The cannula is fixed to one end of the handle so as to form an angle therewith. The plunger system is fixedly attached to the handle and comprises a lever actuated by the user. The lever causes the translational movement of a plunger in the cannula, which makes it possible to force out the fluid contained in the cannula. The plunger moves in translation along the longitudinal axis of the cannula and, to do this, the dispensing system and in particular the lever are located right at the end of the handle. This position of the lever is not comfortable for the user and can prevent them from reaching certain areas: in fact, the finger of the user which actuates the lever must be located at the very end of the handle near the cannula, which makes the device too large to be ergonomic. Furthermore, the plunger system comprises elements pivoted on the handle, which makes the device complicated to produce. Finally, with the device of EP 0 237 182, the length of the plunger is fixed, which makes the device compatible with a small number of cannula sizes. Depending upon the cannula sizes (and thus the amounts of filling fluid the user needs) it will thus be necessary to provide several different devices, i.e. several handles with a separate plunger system and a set plunger length.

The problems described above for endodontic treatment are also applicable for treatment of the coronal part of the tooth, during treatment for conservation of the pulp vitality (pulp capping for example). Hereinafter, the phrase “root canal system of a tooth” refers to the root canal(s) of a tooth as well as the pulp chamber in the coronal part of the tooth.

The aim of the present invention is thus to obtain a medical or dental device for dispensing a pasty or liquid composition and in particular a pasty or liquid endodontic filling material which overcomes the stated disadvantages and which is in particular ergonomic, easy to fabricate, easy to clean, precise in use and which allows precise delivery of said pasty or liquid composition in terms of quantity and positioning, even in areas difficult to access.

The present invention relates to a medical or dental device for dispensing a pasty or liquid composition as claimed in claim 1.

The appended figures illustrate schematically and by way of example two embodiments of a device in accordance with the invention.

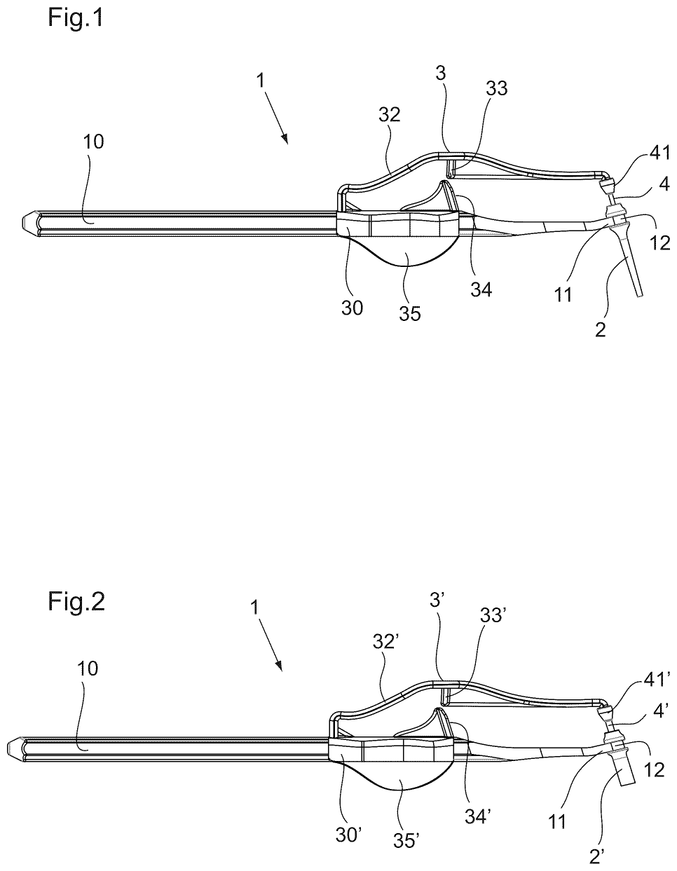

FIG. 1 illustrates a first embodiment of a medical or dental device for dispensing a pasty or liquid composition in accordance with the invention in a first configuration.

FIG. 2 illustrates the medical or dental device for dispensing a pasty or liquid composition of the first embodiment in a second configuration.

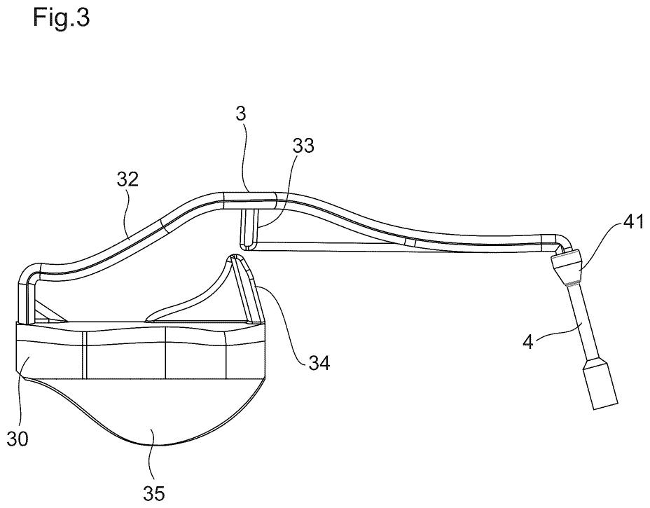

FIG. 3 illustrates in particular the lever/plunger assembly of the device of FIG. 2.

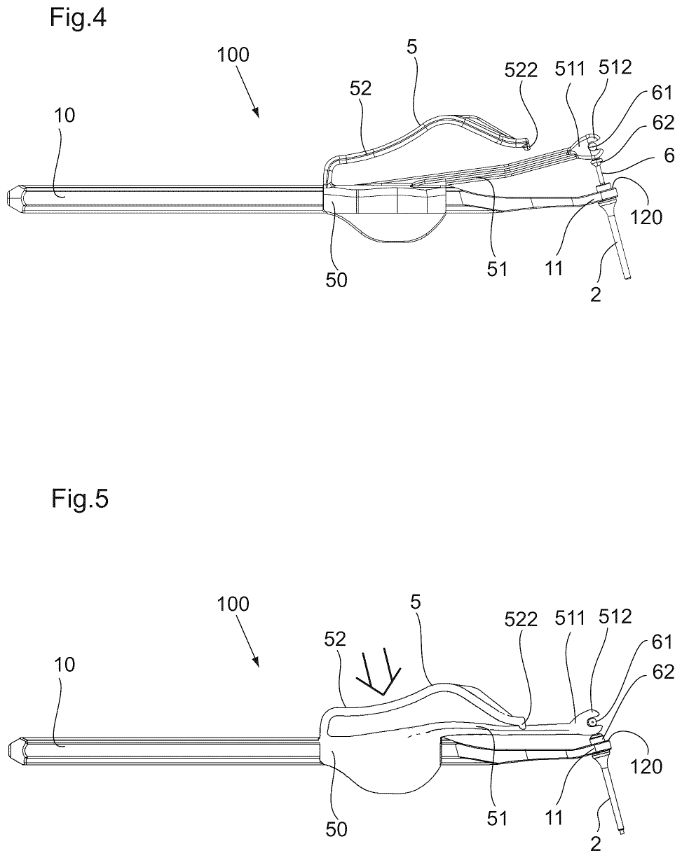

FIG. 4 illustrates a second embodiment of a medical or dental device for dispensing a pasty or liquid composition in accordance with the invention in a first position.

FIG. 5 illustrates the medical or dental device for dispensing a pasty or liquid composition in accordance with the second embodiment in a second position.

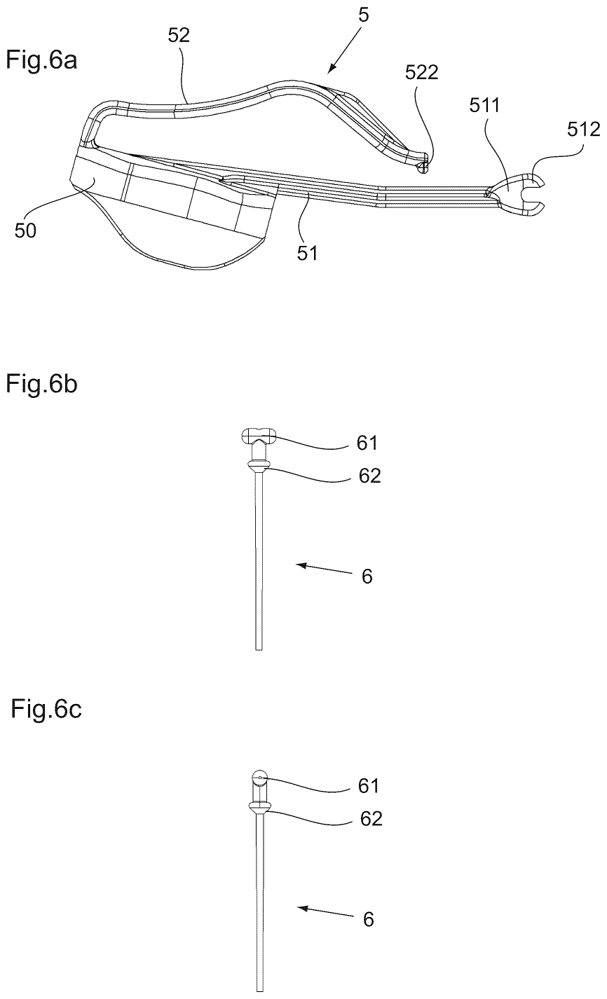

FIGS. 6a to 6c respectively illustrate the tube and the plunger, as an end view and a profile view.

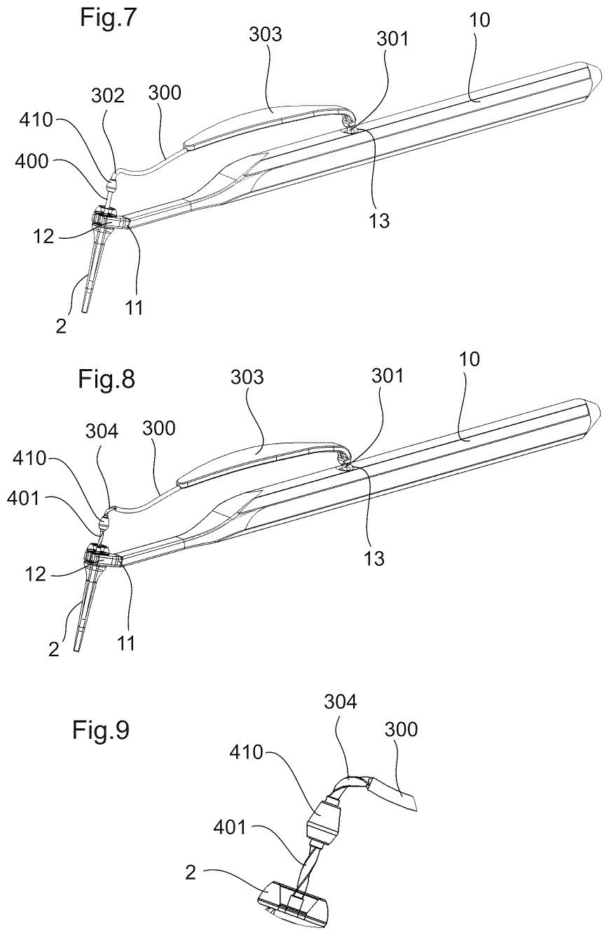

FIGS. 7 to 9 illustrate variants of the first embodiment, FIG. 9 being an enlargement of a portion of FIG. 8.

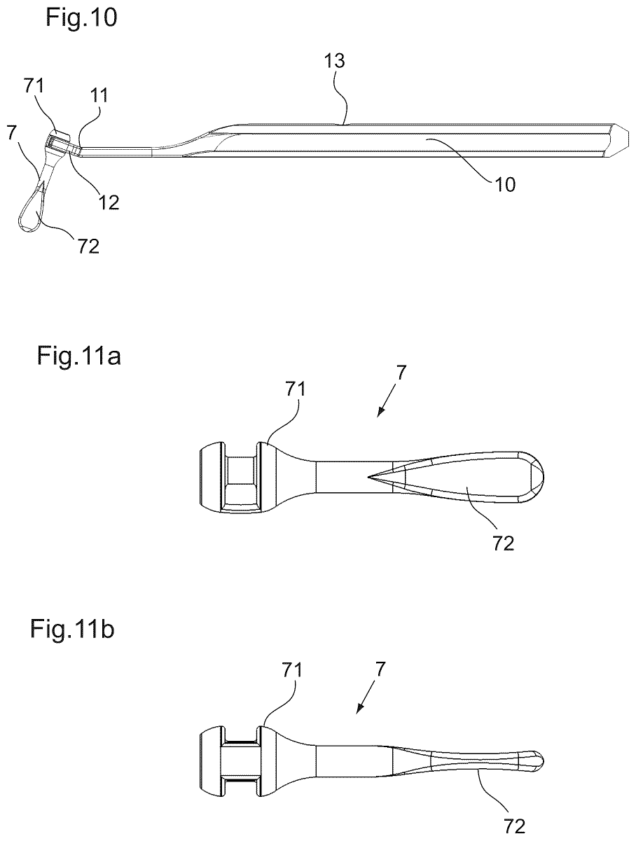

FIGS. 10 to 11b illustrate a dental instrument intended for apical retrofilling or retrograde filling of a root canal.

In the first embodiment illustrated in FIGS. 1 to 3, the medical or dental device for dispensing a pasty or liquid composition in accordance with the invention is an endodontic device 1 intended to dispense a pasty or liquid endodontic filling material such as a cement or paste in the root canal system of a tooth during endodontic treatment for filling a canal or treatment of the coronal part of the tooth.

The endodontic device 1 comprises a handle 10 intended to be gripped by the user. As illustrated in this first embodiment, the handle 10 is substantially straight as a whole. As a variant, the handle can likewise have one or more zones, the shape of which improves the ergonomics and gripping of the handle 10.

The handle 10 has an active end 11 and, at this end, a clamp 12 intended to receive and retain on the handle 10 at least one tube 2 containing the pasty or liquid filling material. The tube 2 can be filled prior to being fixed to the handle 10 or can be filled after it is fixed to the handle 10 (for example, in an endodontic application, by compacting the pasty or liquid filling material in the tube by tapping said tube 2 on a mass of pasty or liquid filling material prepared by the user).

The tube 2 forms a reservoir for the pasty or liquid composition to be dispensed, whilst the clamp 12 forms means for fixing this reservoir to the handle 10. Preferably, the tube 2 is removably mounted on the handle 10.

In accordance with the invention, the endodontic device 1 comprises at least one plunger 4 shaped to be able to slide in the tube 2 to push the pasty or liquid filling material contained in said tube 2 out of the tube and thereby permit dispensing of said material.

The endodontic device 1 further comprises at least one lever 3 which can be actuated by a user and is arranged to be removably fixed to a portion of the handle 10 provided for this purpose. The lever 3 is arranged to cooperate with the plunger 4 to cause said plunger 4 to slide in the tube 2 to permit the dispensing of the pasty or liquid filling material contained in said tube.

In accordance with the invention, the clamp 12 is shaped such that the tube 2 held in said clamp 12 forms an angle with the longitudinal axis of the portion of the handle 10 which receives the lever 3. In the first illustrated embodiment, since the handle 10 is substantially straight the tube 2 thus forms an angle with the longitudinal axis of the handle 10 when said tube 2 is retained in the clamp 12.

In the first illustrated embodiment, the lever 3 and the plunger 4 are fixedly attached to each other and formed in one piece. The lever 3 comprises a base 30 arranged to be removably mounted on the handle 10 and a lever rod 32 which can be actuated by the user and connects the base 30 to the plunger 4. The lever 3-plunger 4 assembly is arranged such that, when the lever 3 and the tube 2 are mounted on the handle 10 and the plunger 4 is inserted in the tube 2, a pressure on the lever rod 32 in the direction of the base 30 causes the movement of the plunger 4 in the tube 2 to allow the pasty or liquid filling material to be delivered from the tube 2.

Preferably, the lever rod 32 is flexible and arranged so that pressure exerted on said lever rod 32 in the direction of the base 30 causes movement of the plunger 4 in the tube 2 even if the pressure is not in a direction in parallel with that of the tube 2. The lever 3 is thus arranged to move the plunger 4 both in translation along the longitudinal axis of the tube 2 and in translation along an axis in parallel with the axis of the portion of the handle 10 (thus of the handle 10 in the 10 first illustrated embodiment) to retain the parallelism between the plunger 4 and the tube 2. The lever rod 32 is in the form of a flexible arm which allows the pressure exerted by the user to be transmitted to the plunger 4 whilst being able to be deformed since the plunger 4 can move only in a direction in parallel with the longitudinal axis of the tube 2 which is generally not the direction in which the lever 3 and the lever rod 32 are pressed. As a variant, the lever 3 could have one or more joints between the base 30, the lever rod 32 and the plunger 4 which are shaped to ensure the movement of the plunger 4 in the tube 2.

Preferably, to ensure optimum sliding of the plunger 4 in the tube 2, the lever 3 further comprises guide means intended to guide the movements of the lever rod 32 when a user exerts pressure on said lever rod 32 in the direction of the base 30. In the illustrated embodiment, the guide means comprise a lug 33 fixedly attached to the lever rod 32 and arranged to cooperate with a guide surface 34 fixedly attached to the base 30 of the lever 3. When the user presses on the lever rod 32 in the direction of the handle 10, the lug 33 slides on the guide surface 34 thereby ensuring suitable movement of the lever rod 32 and thus of the plunger 4 in the tube 2. The guide surface 34 can also be used as a stop for the lug 33 and/or for the lever rod 32 and thus limit the travel of said lever rod 32.

Preferably, the base 30 of the lever 3 further comprises zones 35 shaped to improve the gripping and/or mounting/dismounting of the lever 3 on/from the handle 10 (contact zone for the fingers of the user, releasing zone . . . ).

In the illustrated embodiment, the endodontic device 1 for dispensing a pasty or liquid filling material further comprises a second lever 3′/plunger 4′ assembly. FIG. 1 illustrates the endodontic device 1 in accordance with the first embodiment with a lever 3/plunger 4 assembly arranged to cooperate with a tube 2 with a diameter of 1 mm. FIG. 2 illustrates the same device 1 in accordance with the first embodiment but, this time, a second lever 3′/plunger 4′ assembly is mounted on the handle 10 and arranged to cooperate with a second tube 2′ with a diameter of 2 mm. This second lever 3′/plunger 4′ assembly is in every way similar to that described above, the only difference being that the plunger 4′ is shaped to be able to slide in a tube 2′ with a diameter of 2 mm, whilst the plunger 4 of the first lever 3/plunger 4 assembly is shaped to be able to slide in a tube 2 with a diameter of 1 mm. Therefore, in this first embodiment the endodontic device 1 for dispensing pasty or liquid filling material comprises a handle 10, at least two tubes 2, 2′, which are characterised by different sizes, and at least two corresponding lever/plunger assemblies 3, 4, 3′, 4′. By using tubes of different diameters, it is possible to vary the applications: thin tube for filling a root canal, thicker tube for treating the coronal part of the tooth. The other dimensions of the tube are preferably selected to correspond to a predetermined amount of filling material to be dispensed.

In order to use the device in accordance with the first embodiment of the invention, the user selects a tube 2, 2′ of suitable size (in the illustrated embodiment, a tube with a diameter of 1 or 2 mm). This tube 2, 2′ is then fixed in the clamp 12 at the active end 11 of the handle 10 of the device. The user can then select the lever 3, 3′/plunger 4, 4′ assembly whose size corresponds to that of the selected tube 2, 2′ and mount (e.g. clip) this lever 3, 3′ on the portion of the handle 10 provided for this purpose. As a variant, the handle 10 can have guides indicating to the user precisely where the lever 3, 3′ should be mounted. For example, clipping means can be provided between the handle 10 and the base 30, 30′ of the lever 3, 3′.

As indicated above, the tube 2, 2′ can be pre-filled prior to being mounted on the handle 10 or can be filled (e.g. by compacting) once it is mounted on the handle 10.

Once the lever 3, 3′ is mounted on the handle 10, the user can then introduce the plunger 4, 4′, fixedly attached to said lever 3, 3′, into the tube 2, 2′. This operation is possible and simple owing to the flexible lever 32, 32′ which can be sufficiently deformed to introduce the plunger 4, 4′ into the tube 2, 2′ when the lever 3, 3′ and the tube 2, 2′ are mounted on the handle 10.

The device is thus ready to be used: by pressing on the lever rod 32, 32′ in the direction of the base 30, 30′, the plunger 4, 4′ will slide in the tube 2, 2′ and deliver the contents of said tube 2, 2′ precisely into the selected area. Preferably, the plunger 4, 4′ comprises a stop 41, 41′ which limits the travel of the plunger 4, 4′ in the tube 2, 2′ and guarantees that a precise and pre-set amount of pasty or liquid filling material can be delivered.

Once the operation is finished, the plunger 4, 4′ can be removed from the tube 2, 2′ and the lever 3, 3′ and the tube 2, 2′ can each be dismounted from the handle 10. Preferably, the lever/plunger assembly is cleaned and reused (sterilised) whilst the tube 2, 2′ is thrown away. As a variant, the tube 2, 2′ could also be reused, the cleaning thereof being facilitated by the fact that the plunger can be fully removed from said tube.

In this first embodiment, the lever 3, 3′/plunger 4, 4′ assembly is a monobloc assembly or is made from a single piece. In an even more preferred manner, this lever 3, 3′/plunger 4, 4′ assembly is monolithic, i.e. it is moulded/cut-out/etched/machined in a single piece from the same material. As a variant, the plunger can be added onto the lever, the lever can be added onto the base and these three elements can be made of identical or different materials and assembled together to form a monobloc component.

FIGS. 7 to 9 illustrate a variant of this first embodiment. In this variant, the lever 300/plunger 400 assembly is made from one piece and is made of nickel titanium. The lever 300 is in the form of an NiTi wire, one end 301 of which is intended to be inserted into an orifice 13 provided for this purpose in the handle 10. The second end 302 of the lever 300 is fixedly attached to the stop 410 of the plunger 400. The plunger 400 is itself formed by an NiTi wire shaped to be able to slide in the tube 2 to push the pasty or liquid filling material contained in said tube 2 out of the tube and thereby permit dispensing of said material.

The lever 300 and in particular the diameter, section and curvature of the NiTi wire are selected such that said lever 300 is flexible so that pressure in the direction of the handle 10 causes movement of the plunger 400 in the tube 2, even if the pressure is not in a direction in parallel with that of the tube 2. As in the first embodiment described above, the lever 300 is thus arranged to move the plunger 400 both in translation along the longitudinal axis of the tube 2 and in translation along an axis in parallel with the handle 10 to retain the parallelism between the plunger 400 and the tube 2. The lever 300 is in the form of a flexible NiTi wire which allows the pressure exerted by the user to be transmitted to the plunger 400 whilst being able to be deformed since the plunger 400 can move only in a direction substantially in parallel with the longitudinal axis of the tube 2 which is generally not the direction in which the lever 300 is pressed.

Preferably, a cover 303 is provided on the lever 300 to facilitate handling thereof. This cover 303 can be made in particular of synthetic material and bear an indication of the diameter of the plunger 400 (colour or other marking).

Also preferably, the lever 300 and/or the plunger 400 has at least one portion, the section of which varies (in diameter, in shape and/or in size, for example), in particular with a reduced size and/or diameter, so as to obtain the deformation and flexibility of the lever and/or the plunger which are necessary for effective operation of the device.

In a preferred variant illustrated in FIGS. 8 and 9, the lever 300 has at its end 302 fixedly attached to the stop 410 of the plunger 400 a first helicoidal portion 304. This helicoidal portion 304 is curved and the tapered section of the turns of the helicoid is parametrised based on the expected deformation for the lever 300. Similarly, the plunger 400 preferably likewise comprises a second helicoidal portion 401 immediately adjacent to the stop 410. This second helicoidal portion is substantially straight and the tapered section of the turns of the helicoid is parametrised based on the expected flexibility for the plunger 400. These two helicoidal portions 304 and 401 make it possible to ensure the necessary flexibility for the lever 300/plunger 400 assembly to operate in an optimum manner and to push the pasty or liquid filling material out of the tube 2 when the lever 300 is pressed in the direction of the handle 10.

The functioning of the variant illustrated in FIGS. 7 to 9 is in every way similar to what was described above with reference to the first embodiment. Mounting the lever 300/plunger 400 assembly on the handle is very simple: it is sufficient to insert the first end 301 of the lever 300 into the orifice 13 in the handle 10, place the tube 2 in the clamp 12 of the handle 10 and insert the plunger 400 into the tube 2. As in the first embodiment, this operation is possible owing to the flexibility of the lever 300 and/or of the plunger 400.

This variant offers all the advantages already mentioned relating to the first embodiment. Moreover, the mechanical properties of NiTi make it possible to produce a high-performance lever 300/plunger 400 assembly which offers the practitioner highly precise haptic feedback when dispensing the contents of the tube 2.

FIGS. 4 to 6c illustrate a second embodiment of a device for dispensing a pasty or liquid composition in accordance with the invention.

In this second embodiment, the medical or dental device for dispensing a pasty or liquid composition in accordance with the invention is an endodontic device 100 intended to dispense a pasty or liquid endodontic filling material such as a cement or paste in the root canal system (root canal or pulp chamber) of a tooth during endodontic treatment for filling a root canal or during treatment of the coronal part of the tooth.

Elements which are identical or quasi-identical to those described in the first embodiment have the same reference numerals.

As in the first embodiment, the endodontic device 100 in accordance with the second embodiment comprises a handle 10 intended to be gripped by a user. The handle 10 has an active end 11 and, at this end, a hole 120 intended to receive and retain on the handle 10 a tube 2 containing the liquid or pasty filling material. In this embodiment, the tube 2 is thus forcibly driven into the hole 120 in order to be mounted on the handle 10. As a variant, the hole 120 and the tube 2 could each comprise snap-fit means enabling the tube 2 to be snap-fitted into the hole 120.

The tube 2 can be filled prior to being fixed to the handle 10 or can be filled after it is fixed to the handle 10 (for example, in an endodontic application, by compacting the liquid or pasty filling material in the tube by tapping said tube 2 on a mass of filling material prepared by the user). In this second embodiment, the means for fixing the tube 2 to the handle 10 are thus formed by the hole 120 and the tube 2 is frictionally driven or inserted on said handle.

In accordance with the invention, the endodontic device 100 comprises at least one plunger 6 shaped to be able to slide in the tube 2 to push the pasty or liquid filling material contained in said tube 2 out of the tube and thereby permit dispensing of said material.

The endodontic device 100 further comprises at least one lever 5 which can be actuated by a user and is arranged to be removably fixed to a portion of the handle 10 provided for this purpose. The lever 5 is arranged to cooperate with the plunger 6 to cause said plunger 6 to slide in the tube 2 to permit the dispensing of the pasty or liquid filling material contained in said tube.

In accordance with the invention, the means for fixing the tube to the handle, and thus the hole 120, are shaped such that the tube 2, once driven into said hole 120, forms an angle with the longitudinal axis of the portion of the handle 10 which receives the lever 5.

Contrary to the first embodiment, in the second embodiment the lever 5 and the plunger 6 are not made from one piece.

The lever 5 comprises a base 50 arranged to be removably mounted on the handle 10. The base 50 can, for example, be clipped to the handle 10. The lever 5 further comprises a first flexible arm 51 extending from the base 50 and comprising, at its free end 511, a connecting member 512 having, in this case, the shape of a beak 512 intended to cooperate with one end of the plunger 6. The lever 5 further comprises a second flexible arm 52 also extending from the base 50 and forming the lever rod which can be actuated by the user.

The plunger 6 has one end 61 shaped so as to cooperate with the beak 512. The beak 512 of the lever 5 and the end 61 of the plunger 6 are shaped such that the end 61 can be inserted into the beak 512 in order to return to an in-use position in which the plunger 6 is fixedly attached to the first flexible arm 51 of the lever 5, i.e. in which movement of the beak 512 of the first flexible arm 51 causes movement of the plunger 6. In particular, the end 61 of the plunger 6 and the beak 512 of the first flexible arm 51 of the lever 5 are arranged such that, once the end 61 of the plunger 6 is inserted into the beak 512 of the lever 5 in its in-use position, any flexing of the first flexible arm 51 causing movement of the beak 512 also causes movement of the plunger 6. Preferably, the beak 512 and the plunger 6 are again arranged such that the plunger 6 can be removed from the beak 512 from its in-use position so as to detach said plunger 6 from the lever 5.

In order to use the device 100 according to the second embodiment, the user takes a tube 2 of the desired size, which may or may not be pre-filled with filling material. This tube 2 is then frictionally driven on the handle 10 into the hole 120. The plunger 6 corresponding to the size of the tube 2 is then partially inserted into the tube 2. If the tube is pre-filled, the plunger 6 is inserted into the tube without any force, i.e. without any pressure which could push the contents of the tube 2 out of the tube. The plunger 6 is then connected to the lever 5 by way of the connecting member 512 of the first flexible arm 51 of said lever. For this purpose, the end 61 of the plunger 6 is inserted into the beak 512 as far as its in-use position. In this second embodiment, the beak 512 is substantially in the shape of a fork with a first longitudinal slot and a second slot perpendicular to the first, whilst the end 61 of the plunger 6 is T-shaped. The beak 512 and the end 61 are shaped to enable facilitated assembly in the following manner:
the user places the plunger 6 in a position substantially in parallel with the longitudinal axis of the first flexible arm 51 of the lever 5;
the user then inserts the end 61 of the plunger 6 into the beak 512 of the first flexible arm 51 of the lever 5, more particularly into the first slot of the beak 512;
finally, the user causes the plunger 6 to pivot with respect to the first flexible arm 51 of the lever 5 to bring the plunger 6 into its in-use position, in which the main rod of the plunger 6 is located in the second slot.

Once the plunger 6 is in its in-use position in the lever 5, said lever can be mounted (clipped) to the portion provided for this purpose on the handle 10 of the device. The device 100 is then in the configuration illustrated in FIG. 4, ready for use.

The user presses onto the second flexible arm 52 of the lever 5 in the direction of the base 50 and of the handle 10. The active end 522 of said second flexible arm 52 then comes into contact with the first flexible arm 51 of the lever 5 and causes the movement of the first flexible arm 51. That being done, the active end 522 of the second flexible arm 52 slides along the first flexible arm 51 in the direction of the beak 512. The first flexible arm 51 drives the plunger 6 which slides into the tube 2 to push the contents of said tube 2 out of the tube and dispense the filling material.

To enable the sliding of the plunger 6 into the tube 2, the beak 512 and the active end 61 of the plunger 6 are also arranged such that, in the in-use position of the plunger 6 on the first flexible arm 51 of the lever 5, there is some clearance between the active end 61 and the beak 512 both in a direction substantially in parallel with the longitudinal axis of the plunger 6 and in a direction substantially in parallel with the longitudinal axis of the first flexible arm 51. In other words, the active end 61 can move slightly in the beak 512 in the in-use position of the plunger 6 in order to ensure that the plunger 6 slides in an optimum manner in the tube 2 when the lever 5 and its first flexible arm 51 are pressed in the direction of the handle 10. In the second illustrated embodiment, this clearance can be seen in FIG. 5 and is permitted by the shape of the first and second slots of the beak 512.

The active end 522 of the second flexible arm 52 can be arranged to become snap-fitted into a groove provided for this purpose in the first flexible arm 51 when the second flexible arm 52 is pressed in the direction of the handle 10. Therefore, above a certain amount of pressure, the second flexible arm 52 becomes fixedly attached to the first flexible arm 51. This makes it possible in particular to guarantee precise operation of the device and to avoid deviation of the second flexible arm 52 which would prevent effective contact between the 20) active end 522 of the second flexible arm 52 and the first flexible arm 51. Preferably, the active end 522 of the second flexible arm 52 and the groove of the first flexible arm 51 with which it cooperates are arranged such that said active end 522 can be detached from the groove so as to return the lever 5 to a rest position as illustrated in FIG. 4 or 6a.

Preferably, the plunger 6 comprises a stop 62 which limits the travel of the plunger 6 in the tube 2 and guarantees that a precise and pre-set amount of pasty or liquid filling material is delivered.

Once the filling material contained in the tube 2 has been dispensed, it is possible to remove the lever 5 from the handle 10, to detach the plunger 6 from the lever 5, to remove the plunger 6 from the tube 2 and to dismount the tube 2 from the handle 10. It is feasible to collect, clean and reuse each of these parts. However, preferably the tube 2 and the plunger 6 are single-use items whereas the lever 5 is provided to be able to be reused, i.e. cleaned and sterilised.

As in the first embodiment, the device 100 can comprise several tubes of different diameters. A corresponding plunger is associated with each tube. Preferably, a single lever is arranged to be able to cooperate with each of the plungers, i.e. each plunger has a substantially identical active end arranged to cooperate with the connecting member of the first flexible arm of the lever. As a variant, the device could comprise several levers arranged to each cooperate with a plunger of a set size.

The above two embodiments have been described by way of example only and other variants are possible.

The tube 2 can be flexible so as to be able to best follow the shape of the root canal and reach areas difficult to access.

As indicated above, the tube or reservoir can be mounted on the handle when empty or pre-filled. In the case where is pre-filled, the reservoir can be delivered as a single-dose item, ready for use and for a single use, which is packaged in individual sterile pouches or closed by membrane seals. In this latter case, the lever/plunger assembly in accordance with the invention can be arranged to allow the plunger to pierce each of the membrane seals closing the reservoir during assembly of the device in accordance with the invention and during use thereof.

Preferably, and in particular for endodontic use, the handle 10 of the device is made of metal such as NiTi or of stainless steel. However, any other suitable material could be used, such as resins, composite materials or thermoplastics. This is also true for the tube 2 containing the pasty or liquid composition. Preferably, the lever and/or plunger of the device in accordance with the invention is made of synthetic material or of NiTi, regardless of whether the lever and plunger are made in a single piece or are produced separately.

In the above embodiments, the tube or reservoir is mounted on the handle clipped into clamps or frictionally driven into a hole. As a variant, any suitable fixing means could be used to permit the, preferably removable, mounting of the tube (or reservoir) of liquid or pasty composition on the handle of the device in accordance with the invention.

Furthermore, in the case where said means for fixing the tube to the handle are arranged to allow removable mounting of said tube, it is possible to complement or convert the device in accordance with the invention for other applications. FIG. 10 illustrates in particular the possibility of mounting, on the device 1, 100 as described in the preceding embodiments, a spatula arranged to allow the dispensing of a suitable pasty composition (e.g. cement known as putty) in the case of apical retrofilling or retrograde filling of a root canal. Apical retrofilling takes place after exeresis of a cyst in the apex of a tooth when conventional treatment passing through the crown of the tooth is not possible. With regard to infection, the gingiva is incised and spread apart so as to reveal the nidus and the end of the root. This end in contact with the infection is severed and the entire cavity is cleaned. The orifice of the root canal is then enlarged and filled with a suitable material (retrofilling). To perform this particular filling, the practitioner normally uses a spatula or a plugger. The orifice to be filled must be as small as possible and access thereto is often complicated: therefore, instruments with an end which is thin and angular are preferable.

Considering the handle 10 of the devices 1, 100 described above, it is possible to mount a fitting 7 on said handle in the clamp 12 or hole 120. This fitting 7 comprises a fixing end 71 intended to cooperate with the means for fixing the tube to the handle 10, such as the clamp 11 in FIG. 10, and an active portion 72 being used as a spatula or plugger. Preferably, the active portion 72 can be used on both sides. Preferably, the active portion 7 has a width less than 5 mm, in a preferred manner 4 mm or 2 mm. The active portion 72 can be flat but preferably, and as illustrated in FIG. 11a, has the shape of a spoon on at least one, but preferably two, side(s). Preferably, the fitting 7 is made from synthetic material or stainless steel. Any other suitable material can be used.

By combining the handle 10 with a fitting 7, a dental instrument is thus produced which is intended for apical retrofilling or retrograde filling of a root canal allowing a suitable filling material to be dispensed and compacted in a retrograde manner. In particular, the angulation of the means for fixing the tube 2 to the handle 10 which also receive the fitting 7 makes it possible to produce an instrument, the spatula of which is angular for better access to the apical area to be treated. Moreover, by separating the fitting from the handle it is easy and economical to provide several fittings 7 of different sizes for a single handle, the practitioner thus being able to select the one which best corresponds to a particular case. The fitting 7 could have any suitable shape for dispensing and/or compacting a filling material in the case of apical retrofilling. In particular, the fitting could comprise a first portion extending along a first axis, the flat active portion forming an angle with this first axis. This new angulation of the spatula in addition to the angulation between the handle and the fitting can be useful depending upon the position of the tooth to be treated.

A device for dispensing a pasty or liquid composition is thus produced which is particularly versatile since a single handle can be arranged to receive several sizes of tubes (or reservoirs) and the plungers and/or levers associated with each size and/or other fittings intended for the dispensing and/or compacting. Gripping of the device, both in terms of its use and the interchangeability of the tubes (or reservoirs) and plungers, is easy, with a rapid learning curve (good mastery of the device does not require a large amount of experience or long use but is acquired very quickly).

The device in accordance with the invention is also precise and effective: it allows a precise amount of the composition contained in the tube or reservoir to be easily delivered, even in areas difficult to access (amount set by the size of the tube, and the travel of the plunger). Moreover, by always guaranteeing the same travel for the plunger in the reservoir whatever the force applied to the lever, the result, and in particular the amount of material delivered out of the tube, is predictable and precise, which is an advantage for the user, in particular in the dental and endodontic field.

The device is also easy to produce since each element-handle, reservoir, lever and/or plunger—can be machined separately as a “simple” element prior to being assembled to form a complex device. Each element of the device can be produced relatively easily by known and approved production techniques and from materials which are suitable for said particular element.

The device in accordance with the invention also facilitates the cleaning and sterilising, again because each component-handle, lever, plunger and reservoir—can be treated separately and is easier to clean than the known devices.

The device is also ergonomic because the portion of the lever which can be actuated by the user can be arranged and positioned on the handle in order to guarantee good gripping by the user whilst being away from the active end of the handle and the reservoir, thereby preventing the lever or the hand of the user from hindering access to the area to be treated during use of the device.

The above embodiments have been described by way of example. Generally, the device for dispensing a pasty or liquid composition in accordance with the invention is intended for medical or dental use and comprises
a handle,
a reservoir for the pasty or liquid composition, said reservoir being pre-filled or not (tube),
at least one plunger arranged to slide in the reservoir,
at least one lever arranged to be removably mounted on a mounting portion of the handle and arranged to cooperate with the plunger to cause said plunger to slide in the reservoir for the dispensing of the pasty or liquid composition contained therein when the reservoir and the lever are mounted on the handle;
means for fixing said reservoir to an active end of said handle, which are arranged to make it possible to fix the reservoir, preferably removably, to said active end of said handle such that when the reservoir is fixed to the handle, said reservoir forms an angle with the longitudinal axis of the mounting portion of the handle.

The lever is arranged to be connected to the plunger such that when the user presses on the lever in the direction of the handle, the plunger slides in the reservoir along the longitudinal axis thereof and pushes the pasty or liquid composition out of said reservoir.

As a variant, the lever and the plunger are made from a single piece. The lever can thus comprise a base and at least one flexible portion connecting the base to the plunger. The flexible portion is arranged to allow the insertion of the plunger in the reservoir once the reservoir is mounted on the handle and the base of the lever is mounted on the handle and to allow the sliding of the plunger in the reservoir along the longitudinal axis of said reservoir when the lever and said at least one flexible portion are pressed in the direction of the handle in a direction which is not in parallel with the longitudinal axis of the reservoir.

In this first variant, the lever can comprise guide means arranged to guide the movement of the lever and the deformation of its flexible portion in order to ensure optimal sliding of the plunger in the reservoir.

The lever and the plunger can also be made from a single piece of nickel titanium. Preferably, at least the plunger or the lever comprises a portion with a variable section which is characterised by sections which have a size and/or diameter which is smaller than the size and/or diameter of a section of the rest of the lever or plunger so as to obtain the deformation and flexibility of the lever and/or of the plunger which are necessary so that when the user presses on the lever in the direction of the handle, the plunger slides in the reservoir along the longitudinal axis thereof and pushes the pasty or liquid composition out of said reservoir. Preferably, the portion(s) with a variable section are portions with a helicoidal section.

In another variant, the lever comprises a first flexible arm terminated by a connecting member intended to cooperate with the plunger such that the plunger can be inserted into the connecting member in order to return to an in-use position. The link between the connecting member and the plunger is such that, in the in-use position, when the lever and the reservoir are mounted on the handle, movement of the first flexible arm causes the sliding of the plunger in the reservoir along the longitudinal axis of said reservoir. The lever further preferably comprises a second flexible arm arranged to cooperate with the first flexible arm such that, by pressing on the second flexible arm in the direction of the handle, said second flexible arm comes into contact with the first flexible arm and moves it to cause the plunger to slide in the reservoir and thereby dispense the composition contained in said reservoir.

In this second variant, there is preferably a clearance between the connecting member and the plunger when this is in its in-use position such that the plunger can slide in the reservoir along the longitudinal axis thereof even if the pressure exerted on the lever is in a direction which is not in parallel with said longitudinal axis of the reservoir.

Preferably, the plunger comprises a stop intended to cooperate with the reservoir in order to limit the travel of the plunger in said reservoir.

1. Device (1; 100) for dispensing a pasty or liquid composition intended for medical or dental use, comprising:
a handle (10),
a reservoir (2, 2′) for the pasty or liquid composition, said reservoir (2, 2′) being pre-filled or not,
at least one plunger (4, 4′, 400; 6) arranged to slide in the reservoir (2, 2′),
at least one lever (3, 3′, 300; 5) arranged to be removably mounted on a mounting portion of the handle (10) and arranged to cooperate with the plunger (4, 4′, 400; 6) to cause said plunger (4, 4′, 400; 6) to slide in the reservoir (2, 2′) for the dispensing of the pasty or liquid composition contained therein when the reservoir (2, 2′) and the lever (3, 3′, 300; 5) are mounted on the handle (10);
means (12; 120) for fixing said reservoir (2, 2′) to an active end (11) of said handle (10), which are arranged to make it possible to fix the reservoir (2, 2′), preferably removably, to said active end (11) of said handle (10) such that when the reservoir (2, 2′) is fixed to the handle (10), said reservoir (2, 2′) forms an angle with the longitudinal axis of the mounting portion of the handle (10);
wherein the lever (3, 3′, 300; 5) is arranged to be connected to the plunger (4, 4′, 400; 6) such that when the user presses on the lever (3, 3′, 300; 5) in the direction of the handle (10), the plunger (4, 4′, 400; 6) slides in the reservoir (2, 2′) along the longitudinal axis thereof and pushes the pasty or liquid composition out of said reservoir (2, 2′).

2. Device (1) as claimed in claim 1, wherein the lever (3; 300) and the plunger (4, 400) are made from a single piece.

3. Device (1) as claimed in claim 2, wherein the lever (3) comprises a base (30) and at least one flexible portion (32) connecting the base (30) to the plunger (4), the flexible portion (32) being arranged to allow the insertion of the plunger (4) in the reservoir (2) once the reservoir (2) is mounted on the handle (10) and the base (30) of the lever (3) is mounted on the handle (10) and to allow the sliding of the plunger (4) in the reservoir (2) along the longitudinal axis of said reservoir (2) when the lever (3) and said at least one flexible portion (32) are pressed in the direction of the handle (10) in a direction which is not in parallel with the longitudinal axis of the reservoir (2).

4. Device (1) as claimed in claim 3, wherein the lever (3) comprises guide means (33, 34) arranged to guide the movement of the lever (3) and the deformation of its flexible portion (32) in order to ensure optimal sliding of the plunger (4) in the reservoir (2).

5. Device (100) as claimed in claim 1, wherein the lever (5) comprises a first flexible arm (51) terminated by a connecting member (512) intended to cooperate with the plunger (6) such that the plunger (6) can be inserted into the connecting member (512) in order to return to an in-use position in which the plunger (6) is fixedly attached to the lever (5).

6. Device (100) as claimed in claim 5, wherein there is a clearance between the connecting member (512) and the plunger (6) when this is in its in-use position such that the plunger (6) can slide in the reservoir (2) along the longitudinal axis thereof even if the pressure exerted on the lever (5) and its first flexible arm (51) is in a direction which is not in parallel with said longitudinal axis of the reservoir (2).

7. Device (100) as claimed in claim 5, wherein the lever (5) further comprises a second flexible arm (52) arranged to cooperate with the first flexible arm (51) such that, by pressing on the second flexible arm (52) in the direction of the handle (10), said second flexible arm (52) comes into contact with the first flexible arm (51) and moves it to cause the plunger (6) to slide in the reservoir (2) and thereby dispense the composition contained in said reservoir (2).

8. Device as claimed in claim 2, wherein the lever (300) and the plunger (400) are made from nickel titanium.

9. Device as claimed in claim 8, wherein at least the lever (300) or the plunger (400) comprises a portion with a variable section (304; 401) which is characterised by sections which have a size and/or diameter which is smaller than the size and/or diameter of a section of the rest of the lever (300) or plunger (400) so as to obtain the deformation and flexibility of the lever (300) and/or of the plunger (400) which are necessary so that when the user presses on the lever (300) in the direction of the handle (10), the plunger (400) slides in the reservoir (2) along the longitudinal axis thereof and pushes the pasty or liquid composition out of said reservoir (2).

10. Device as claimed in claim 9, wherein the portion(s) with a variable section (304; 401) is/are a portion with a helicoidal section.

11. Device (1; 100) as claimed in claim 1, wherein the plunger (4; 400; 6) comprises a stop (41; 410; 62) intended to cooperate with the reservoir (2) in order to limit the travel of the plunger (4; 400; 6) in said reservoir (2).

12. Device (1; 100) as claimed in claim 1, comprising at least two reservoirs (2, 2′) having a different size and at least two plungers (4, 4′; 6) corresponding to said reservoirs (2, 2′).

13. Device (1; 100) as claimed in claim 1, wherein the device is an endodontic device and wherein the liquid or pasty material is a cement or a paste for filling the root canal system.

14. Device for dispensing a pasty or liquid composition intended for apical retrofilling or retrograde filling of a root canal, comprising:
a handle (10);
a fitting (7), comprising at least one flat active portion (72);
means (12; 120) for fixing said fitting (7) on an active end (11) of said handle (10) which are arranged to allow removable fixing of the fitting (7) on said active end (11) of said handle (10),
characterised in that when the fitting (7) is fixed to the handle (10), the longitudinal axis of the active portion (72) of the fitting (7) forms an angle with the longitudinal axis of the handle (10).

15. Device as claimed in claim 14, characterised in that the active portion (72) of the fitting (7) is in the form of a spatula or plugger.
